(19) United States
(12) Patent Application Publication
(10) Pub. No.: US 2025/0091274 A1
(43) Pub. Date: Mar. 20, 2025

(54) MANUFACTURING AND RECYCLING OF PLASTICS VIA SHEAR ASSISTED PROCESSING

(71) Applicant: Battelle Memorial Institute, Richland, WA (US)

(72) Inventors: Xiao Li, Richland, WA (US); Madhusudhan R. Pallaka, Hillsboro, OR (US); Tianhao Wang, Richland, WA (US); Wenbin Kuang, West Richland, WA (US); Kevin L. Simmons, Kennewick, WA (US)

(21) Appl. No.: 18/885,988

(22) Filed: Sep. 16, 2024

Related U.S. Application Data
(60) Provisional application No. 63/538,730, filed on Sep. 15, 2023.

(51) Int. Cl. B29C 48/00; B29C 48/30; B29K 23/00; B29K 105/00; B29K 105/26; C08L 23/06; C08L 23/12

(52) U.S. Cl. CPC B29C 48/022; B29C 48/301; C08L 23/06; C08L 23/12; B29K 2023/0633; B29K 2023/065; B29K 2023/12; B29K 2105/251; B29K 2105/26; C08L 2205/025; C08L 2207/062; C08L 2207/066; C08L 2207/20

(57) ABSTRACT

A method of extruding a polymer composite can include loading into a container feedstock material comprising a first polymer and a second polymer. A rotation-induced shear force can be established at an interface between a face of a die tool and a face of the feedstock material by rotating the feedstock material at a different rate than the die tool. An axial extrusion force can be established at the interface between the face of the die tool and the face of the feedstock material by translating the die tool relative to the container. The feedstock material can be extruded through an opening of the die tool using plastic deformation in response to the rotational shear and the axial extrusion force at the interface.

### CROSS-REFERENCE TO RELATED APPLICATION

This application claims the benefit of priority to U.S. Provisional Patent Application Ser. No. 63/538,730 entitled “HIGH EFFICIENCY MANUFACTURING AND RECYCLING OF PLASTICS VIA SHEAR ASSISTED PROCESSING,” filed Sep. 15, 2023, the disclosure of which is incorporated herein in its entirety by reference.

### STATEMENT AS TO RIGHTS TO DISCLOSURES MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND

Plastics are used in a variety of applications from packaging to consumer products to automotive components. Globally, 400 million tons of plastic are used annually. Commonly used plastics include low density polyethylene (LDPE), high density polyethylene (HDPE), polypropylene (PP), and polyethylene terephthalate (PET). Though plastics are recyclable, the majority of post-consumer plastics are not recycled.

### BRIEF DESCRIPTION OF THE FIGURES

The drawings illustrate generally, by way of example, but not by way of limitation, various aspects of the present invention.

FIG. 1 illustrates perspective view of a shear assisted processing system.

FIG. 2 illustrates a cross-sectional view of a shear assisted processing system.

FIG. 3 illustrates a schematic view of a method of shear assisted processing.

FIG. 4 illustrates portions of a method of shear assisted processing.

FIG. 5 illustrates portions of a method of shear assisted processing.

FIG. 6 illustrates a graph showing properties of products of one or more methods.

FIG. 7 illustrates a graph showing properties of products of one or more

methods. FIG. 8 illustrates portions of a method of shear assisted processing.

FIG. 9 illustrates an isometric view of a portion of a shear assisted processing system.

FIG. 10 illustrates a perspective view of a portion of a shear assisted processing system.

FIG. 11 illustrates a cross-sectional view of a portion of a shear assisted processing system.

FIG. 12 illustrates a method of shear assisted processing.

### DETAILED DESCRIPTION OF THE INVENTION

Currently, there are two primary methods to recycle plastics. The first is using conventional screw extrusion, which is widely used in the plastic industry and recycling industry. However, the screw designs in the extruders are limited in their ability to provide high levels of shear to mix and disentangle polymer strands. Furthermore, the extruders have limited control parameters, such as screw design, screw rotation speed, and temperature to control the shear mixing during extrusion. The second method is thermal processing and mixing of multiple plastic waste streams with the addition of compatibilizers. The downsides are melting temperatures distributed over a wide span of temperature for mixed plastics, different viscosity that causes processing difficulties, phase separation during recrystallization, and inhomogeneous distribution of compatibilizer.

Reclaimed and recycled plastics have been shown to save up to 65% of the energy used to make virgin material according to the American Chemical Society study. On the other hand, a key barrier is recycling single and multi-layer films is that these plastics can be relatively difficult to handle in processing due to the multi-material make up. Existing technologies are limited in their mixing and cannot homogenize and bond the immiscible polymers efficiently.

The present application discusses a shear assisted processing (SAP) method or Shear Assisted Processing and Extrusion (ShAPE) for producing plastics wires, rods, discs, or tubes from pellets or other plastic waste (or recycled material) that can help to address the recycling issues discussed above. During a manufacturing process, shear deformation can be introduced to soften polymer materials that can be deformed, mixed, consolidated, and then extruded. For example, a wire, such as 2.5 mm diameter wire, can be produced from recycled from one or more of polypropylene (PP), polyethylene (PE), a mixture of PP and PE, carbon fiber reinforced plastic (CFRP), polyethylene terephthalate (PETE), polyvinyl chloride (PVC), polystyrene (PS), polyester, polyamide, acrylonitrile butadiene styrene (ABS), acrylate, post-consumer plastic bags, or the like. Differential scanning calorimetry (DSC) shows that the wires made from mixed plastics have good homogeneity. Tensile test results proved the recycled plastics had retained up to 90% strength of raw materials.

SAP is a scalable process that suits mass production in the industry. It has advantages in recycling mixed plastics compared to the conventional methods. SAP is an unprecedented approach to homogenize multi-phase material via shear thinning and mixing despite the miscibility. Different from conventional extrusion, the feed rate and RPM are independent in SAP. So, the shearing effect and mixing time can be controlled separately and tailored efficiently for raw materials consisted of different types and ratios of mixed plastics. Results demonstrate successes in converting mixed PP and PE, CFRP, and post-consumer plastic bags into wire and disc samples with decent strength properties. Parameters of 300-400rpm (3-4 times higher than conventional screw extrusion) can be used to process mixed plastics and produced homogenized wire samples. DSC analysis showed that the PP and PE wire has only one exothermic peak instead of two peaks as PP or PE alone. This result implies that SAP can create a uniform mixture of two phases or even a potential new polymer with improved properties.

Additionally, SAP can help improve energy efficiency and environmentally friendliness. Because it has a lower processing temperature, the SAP process can limit burning. Also, SAP requires only a small amount of focused heating in the region near the die where the material is plasticized. Therefore, the energy efficiency of SAP can be higher than that of the conventional extrusion in which the entire barrel is heated. Further, SAP can reduce the need for high purity sorting and separation processes and may not require additional chemicals. Therefore, SAP can save considerable material, energy, time, equipment, and labor.

The above discussion is intended to provide an overview of subject matter of the present patent application. It is not intended to provide an exclusive or exhaustive explanation of the invention. The description below is included to provide further information about the present patent application.

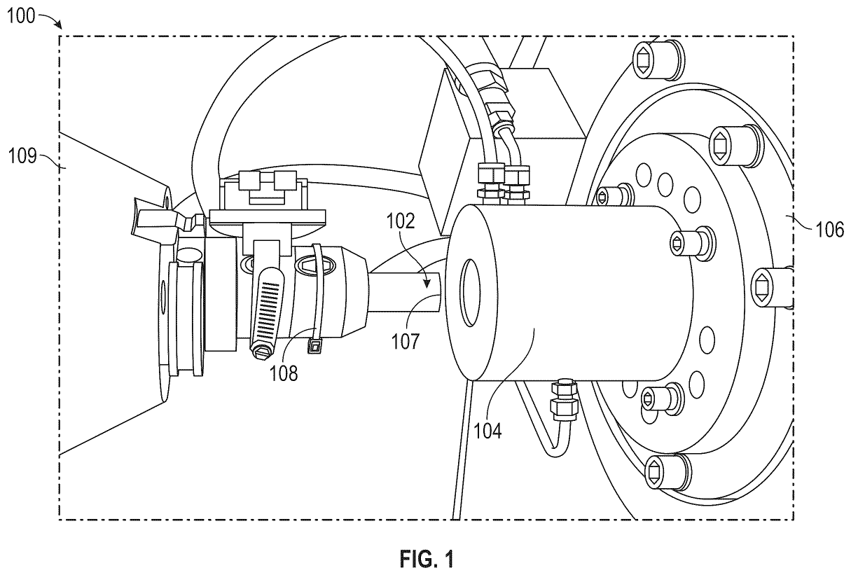

FIG. 1 illustrates perspective view of a shear assisted processing system 100. The system 100 can be configured to perform shear-assisted processing involving applying an axial compression force and a rotation-induced shear force. As shown in FIG. 1, the system 100 can include a die assembly 102, a container assembly 104, a spindle 106, a sensor 107, a die holder 108, and a ram 109. Though the spindle 106 is shown as being connected to the container assembly 104, the spindle 106 can be connected to the die assembly 102. Though the die holder 108 is shown as being connected to the ram 109, the ram 109 can be connected to the container assembly 104. The sensor 107 can be configured to generate a signal and can be connected to the die assembly 102. Operation of the sensor 107 is discussed in further detail below.

In operation of some examples, material, such as one or more recycled or waste polymers can be loaded into the container assembly 104 in the form of a billet or feedstock material. The container assembly 104, including the feedstock material, can be driven to rotate by the spindle 106. The ram 109 can then be operated to translate the die holder 108 to translate the die assembly 102 into the container assembly 104 to engage the feedstock material such that the combination of rotation-induced shear-assisted force between the die assembly 102 and the feedstock material and an axial extrusion force between the die assembly 102 and the feedstock material can perform a shear assisted process to extrude the feedstock material through the die assembly 102 and generate, produce, or form extrudate from the feedstock material.

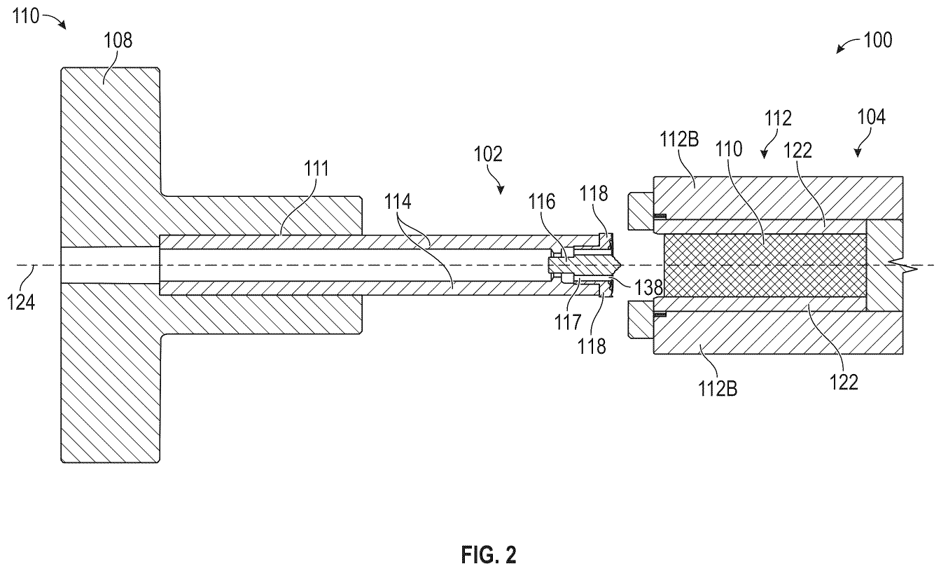

FIG. 2 illustrates a cross-sectional view of the shear assisted processing system 100. The system 100 of FIG. 2 can be consistent with the system 100 of FIG. 1. FIG. 2 shows additional details of the system 100.

For example, FIG. 2 shows that the die assembly 102 can be connected to the die holder 108. FIG. 2 also shows that the container assembly 104 can receive billet material 110 at least partially therein. The die assembly 102 can include an internal portion 111, a die shank 114, a mandrel 116, and a die face 118. The die assembly 102 can also include one or more portholes 117 extending at least partially through the die face 118 and around the mandrel 116, such that the die assembly 102 is configured to generate or produce hollow extrudate. Optionally, the mandrel 116 can be excluded for production of solid extrudate.

The container assembly 104 can also include a container 112 including a container base 112A and a container sidewall 112B that can be used to hold the billet material 110. As shown in FIG. 2, a liner 122 can be in direct contact with the billet material 110 and the container sidewall 112B. In some examples, the billet material 110 can be in direct contact with the container sidewall 112B without a liner 122. In an example where the ram 109 is connected to the container assembly 104, the container base 112A can be movable with ram 109 relative to the liner 122 and the container sidewall 112B. A longitudinal axis (or “central longitudinal axis”) 124 can be defined to extend through a center of the die face orifice.

In operation of some examples, the container 112 can be driven to rotate about a longitudinal axis 124 to a desired speed. The ram 109 can then be operated to translate such that the die face 118 can be thrust against and into the billet material 110 (or vice versa). The die face 118 can include one or more scrolls (e.g., a fluted or spiral topology defining surface contours that direct plasticized material inward as the die face 118 rotates relative to the billet material 110, discussed further below). In some examples, the die face 118 can include other surface features, or can be flat. The die assembly 102 can be operably engaged with the billet material 110 to create a high shear region between the billet material 110 and the die face 118. The rotation about a rotational axis 124 and the axial movement along the axis 124 of the die assembly 102 including the die face 118 can induce shear to plasticize the billet material 110 at or adjacent to the interface between the die face 118 and the billet material 110. The plasticized material can flow in a specified direction.

The system 100 can be configured such that the container 112 and billet material 110 spin and the die face 118 can be translated axially into the billet material 110 such as to provide a combination of shear and compressive forces at the interface between the billet material 110 and the die face 118. The system 100 can also be configured such that the container 112 translates relative to the die face 118 and the die face 118 rotates relative to the container 112. In some examples, the container 112 can rotate and translate and in other examples, the die assembly 102 can rotate and translate. Regardless of which structure is rotated or translated (rammed) in absolutely space relative to the other, the net effect is relative rotation and axial force between the die face 118 and the billet 120 which in turn cause an extrudate to flow out of the die assembly 102.

Flow of the plasticized material can be directed, such as through an extrusion aperture, to another location, such as an internal portion 111 of the die assembly 102. Reconstitution of plasticized material can occur defining a hollow-interior extruded structure (also referred to as an “extrusion product” or an “extrudate”), which can include one or more desired characteristics. Such characteristics can include polymer chain overlapping or non-parallel orientation that can be established using the extrusion through the die face orifice. Use of down-stream processing is optional, and specified microstructure or other physical characteristics can be established using shear-assisted processing alone. The polymer SAP generated extrudate can also be pelletized or cut into relatively smaller pieces resulting in a homogonous pelletized composite of recycled polymers.

While the illustrations of FIG. 1A and FIG. 1B indicate total axial movement or total rotational movement from either the die assembly 102 or the container, examples are not so limited. A majority of the axial movement can occur with the die assembly 102 or a majority of rotational movement can occur with the container while the container may also have slight or lesser axial movement or the die may have slight or lesser rotational movement. That is, the die assembly 102 and the container 112 can move to a lesser degree within the discussed and shown range of movement. For example, one or more of the die assembly 102 or the billet material 110 can move for or within a portion of their range of motion.

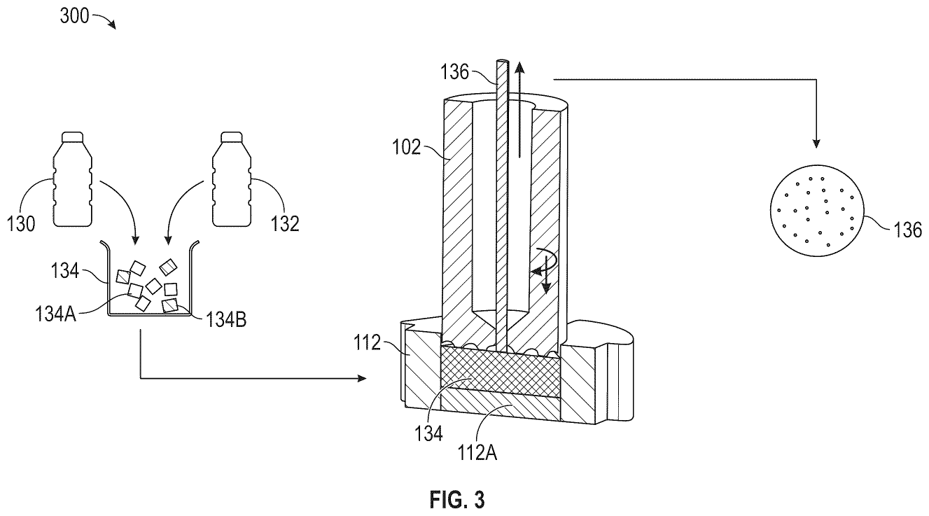

FIG. 3 illustrates a schematic view of a method 300 of shear assisted processing. The method 300 can include receiving a first type of polymer item 130 (e.g., a plastic bottle) and a second type of polymer item 132 (e.g., a bottle, bag, or the like). In some examples, the first type of polymer can be different than the second type of polymer. For example, either of the polymer item 130 and the polymer item 132 can be a thermoplastic polymer or a mixture of thermoplastic polymers. A thermoplastic polymer is a type of plastic material that becomes pliable or moldable when heated and solidifies upon cooling, allowing it to be reshaped multiple times without significant degradation. This reversible process is due to the weak intermolecular forces between polymer chains, which break upon heating and reform upon cooling. Classes of thermoplastic polymers include polyethylene (PE), polypropylene (PP), polyvinyl chloride (PVC), polystyrene (PS), polyethylene terephthalate (PET), polyamides (nylons), polycarbonates (PC), acrylonitrile butadiene styrene (ABS), polymethacrylates (e.g., PMMA), and fluoropolymers (e.g., PTFE). Examples of polyethylenes can include high-density polyethylene (HDPE) or low-density polyethylene (LDPE). HDPE is characterized by its high strength-to-density ratio and minimal branching of polymer chains. It has a density range of about 0.941 to about 0.965 g/cm³. HDPE's structure results in stronger intermolecular forces and higher tensile strength compared to LDPE. It is commonly used in products requiring durability, such as milk jugs, detergent bottles, and pipes. LDPE, on the other hand, has a more branched structure with weaker intermolecular forces. Its density ranges from about 0.910 to about 0.940 g/cm³. LDPE is more flexible and transparent than HDPE, with lower tensile strength and higher ductility. It is often used in applications requiring flexibility, such as plastic bags, squeeze bottles, and some packaging films.

Polypropylene can be a homopolymer polypropylene or a copolymer polypropylene. Homopolymer polypropylene includes a single type of monomer (propylene) repeated throughout the polymer chain. This results in a more crystalline structure with higher stiffness, tensile strength, and hardness. It also has better chemical resistance and a higher melting point compared to copolymer polypropylene. Copolymer polypropylene, on the other hand, incorporates a small amount (e.g., about 1 to about 7%) of another monomer, usually ethylene, into the polymer chain. This can creates a less regular structure, reducing crystallinity and improving impact strength, especially at low temperatures. Copolymer polypropylene is more flexible and has better transparency than homopolymer polypropylene.

One or both of the polymer item 130 or the polymer item 132 can be any of the polymers discussed above (or below) and can be processed at a recycling facility to generate mixed plastic waste 134. The mixed plastic waste 134 can include one or more of the polymers discussed above or can include one or more new or virgin polymers. For example, the mixed plastic waste 134 can include a first polymer 134A and a second polymer 134B where the first polymer 134A and the second polymer 134B can be of the same or different types of polymers. The mixed plastic waste 134 can be processed at a recycling or other facility and can be sorted (e.g., by polymer type) and can be processed to produce flake or pellets. The process waste can also be washed and dried.

Following processing, the mixed plastic waste 134 can be in the form of pellets, flake, compressed material (e.g., billets), or the like, and can be loaded into the container 112 in compressed or non-compressed form (e.g., pellets or flake). The mixed plastic waste 134 can be supported by the container base 112A within the container 112 and can be processed using SAP extrusion. For example, the die assembly 102 can be driven to rotate and translate to form extrudate 136 from the mixed plastic waste 134.

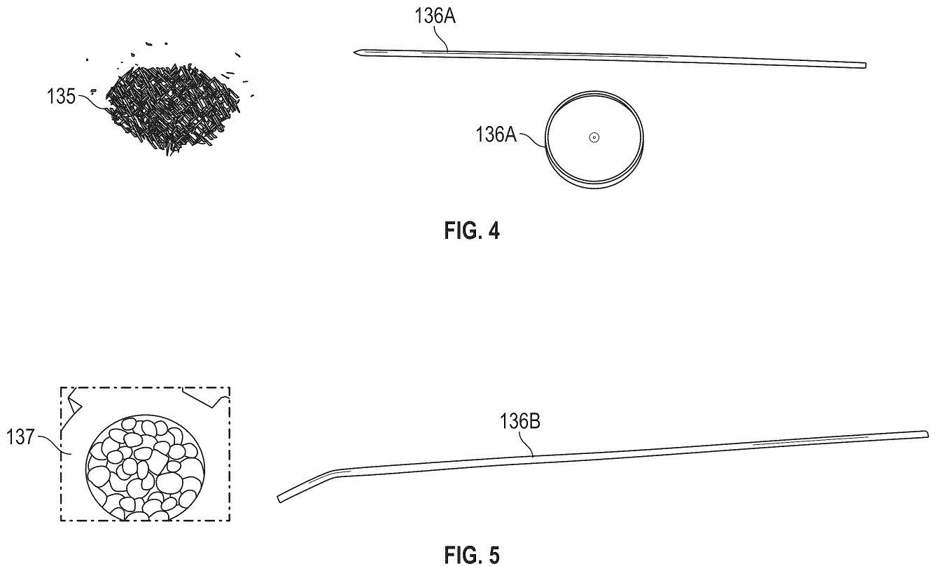

During SAP extrusion, the mixed plastic waste 134 can be mixed and and consolidated in a plurality of pathways in die assembly 102, which can generate extrudate from the feedstock material made of a homogenized mixture of the first polymer and the second polymer. The extrudate 136 can be in the form of a wire or other solid form. Optionally, the extrudate 136 can be hollow, as discussed above. The resulting extrudate can be relatively uniform with small inclusions and fewer inclusions than other methods of processing recycled polymer(s). For example, as shown in FIG. 4, carbon fiber reinforced polymer (CFRP) waste in pellet form or flake, which can be mixed plastic waste 135, can be processed consistent with the method(s) discussed above and can produce or generate extrudate 136A in the form of a solid wire or solid puck.

In the example of generation or production of hollow extrudate using SAP, the polymer strands or chains of the extrudate 136 can be better oriented during the process of SAP or ShAPE. In traditional thermal extrusion, the material splits and connects back together at a knit line, which can result in weaker spots due to an alignment of polymer fibers. However, in SAP or ShAPE extrusion, due to the rotation used in the process, the knit line can be reduced or eliminated and in hollow SAP or ShAPE, the polymer strands or chains of the extrudate 136 can be wound around an outer circumference of the extrudate 136, such as in a helical (and optionally intertwined) arrangement, which can significantly increase a hoop strength of the hollow extrudate.

In the feedstock material the mixture of the first polymer and the second polymer can include the first polymer and the second polymer in substantially the same amount of different amounts. For example, the first or second polymer can independently range from about 5 wt % to about 95 wt % of the mixture, about 30 wt % to about 70 wt %, less than, equal to, or greater than about 5, 10, 15, 20, 25, 30, 35, 40, 45, 50, 55, 60, 65, 70, 75, 80, 85, 90, or about 95 wt % of the mixture.

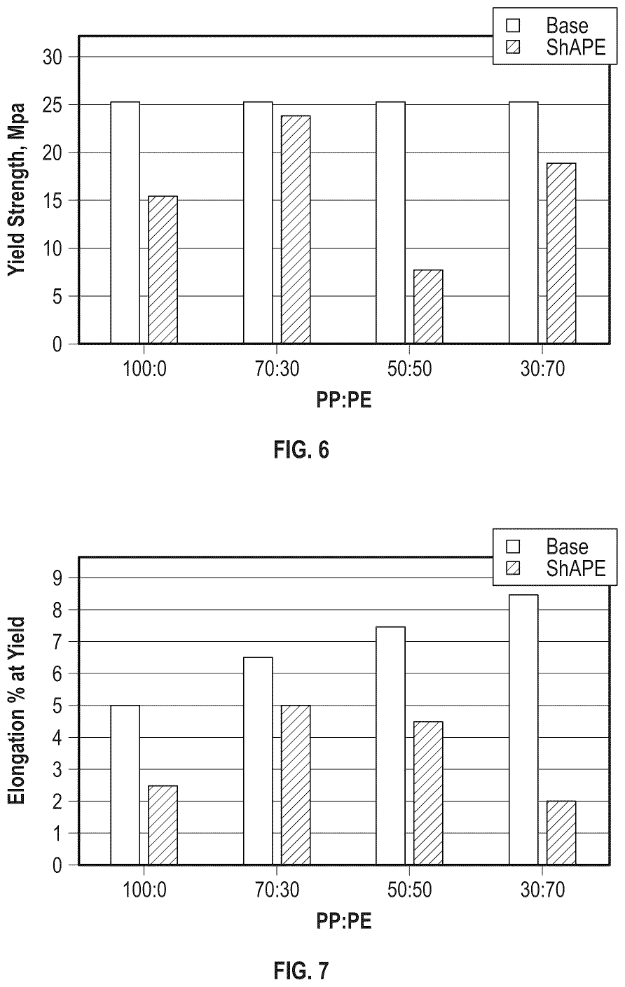

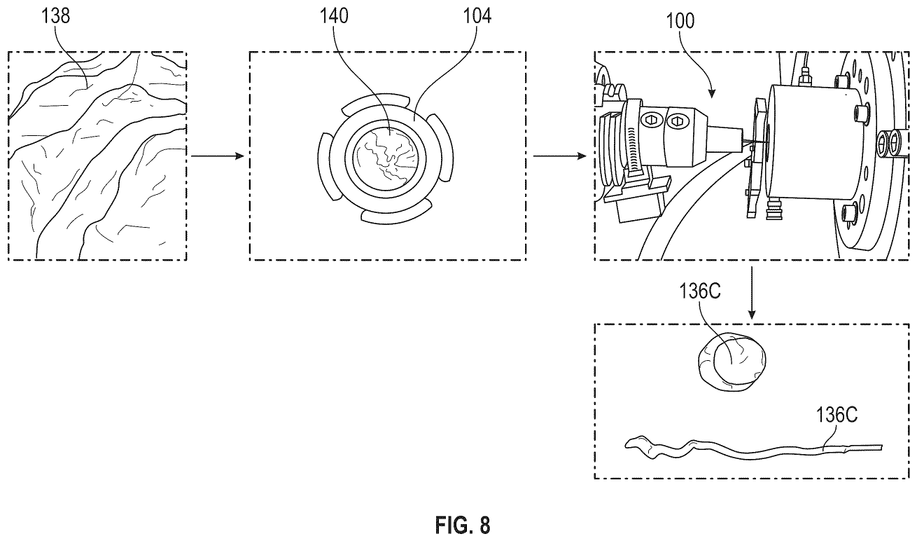

As shown in FIG. 5, a mixture of recycled PP and recycled PE in pellet form or flake, which can be mixed plastic waste 137, can be processed consistent with the method(s) discussed above and can produce or generate extrudate 136B in the form of a solid wire. FIG. 6 shows the properties of combined PP and PE at different ratios of PP to PE (e.g., 100:0, 70:30, 50:50, and 30:70) in base form (or non-recycled form) and in ShAPE form (or in the form of extrudate from recycled PP and PE produced using the processes discussed above). FIG. 6 shows that the ShAPE produced PP and PE mixture can retain a relatively high percentage of its yield strength (in Mega Pascals (MPa)) in most mixture ratios, maintaining more than 90% of the base yield strength at a ratio of 70:30 PP to PE. And, FIG. 7 shows the properties of combined PP and PE at different ratios of PP to PE in base form and in ShAPE form, similar to FIG. 6 above. FIG. 7 shows that the elongation percentage at yield can be maintained in the ShAPE generated extrudate as compared to base materials.

FIG. 8 illustrates portions of a method of shear assisted processing of packing materials, such as polymer air bags 138, which can be made of multiple polymers such as PP and PE. In some examples, the bags can be made of recycled PP and PE. The polymer air bags 138 can be processed such as washed and dried before the bags 138 are compressed and loaded into the container 104 (which can be a liner or billet ring) as compressed bags 140. The compressed bags 140 can be a billet that is loaded into the system 100 where SAP extrusion or ShAPE can be performed as described above to generate extrudate 136C in the form of wire or puck(s). The resulting product can maintain a high percentage of the material properties of the combined polymers while significantly reducing processing steps that would otherwise be required to

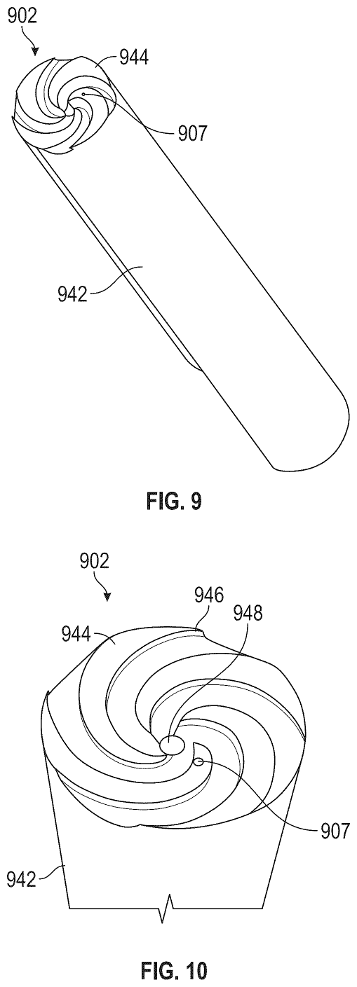

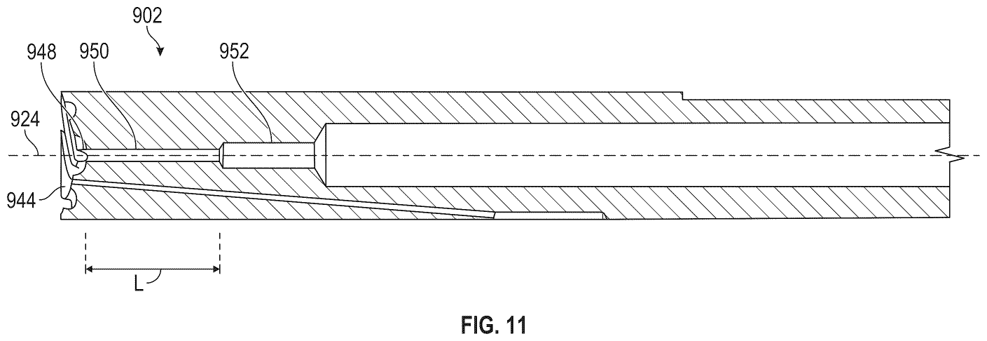

FIG. 9 illustrates an isometric view of a die assembly 902 of a shear assisted processing system, such as the die assembly 102. FIG. 10 illustrates a perspective view of the die assembly 902. FIG. 11 illustrates a cross-sectional view of the die assembly 902. FIGS. 9-11 are discussed together below.

The die assembly 902 can be similar to the die assembly 102 discussed above. The die assembly 902 can include a body 942 that can be elongate. The die assembly 902 can also include a die face 944 located at one end of the body 942. As shown in FIG. 10, the die face 944 can include channels 946 that extend from an outer surface of the die face 944 and into the body 942. The channels 946 can have a swirl, helical, scroll, or otherwise curved pattern or shape such that the channels 946 extend from a radially outer portion of the body 942 or the die face 944 and terminate together at a center of the die face 944 at a bore 948. The channels 946 can be configured to consolidate and homogenize flow of plasticized polymers during the SAP or ShAPE process. Though the die face 944 is shown as including 4 channels, the die face 944 can include 1, 2, 3, 4, 5, 6, 7, 8, 9, or 10 channels or the like. Similarly, the channels 946 can vary in pitch or curvature depending on the one or more polymers being processed where the number of channels and pitch can be optimized to consolidate and homogenize polymer during SAP or ShAPE.

As shown in FIG. 11, the face 944 can be concave or relatively concave, such that the die face 944 can extend from an end portion of the body 942 into the body 942 along a longitudinal axis 924. In operation of some examples, as ShAPE is performed, the rotation-induced shear and axial forces applied to the feedstock material can generate plasticized feedstock material that can flow through the geometries of the die assembly 902, such as the channels 946. Because the die face 944 can be concave and can include the channels 946, the plasticized material can be relatively quickly and thoroughly consolidated or homogenized as the material travels to the bore 948.

FIG. 11 also shows that the bore 948 can extend into the body 942 and can connect to or at least partially form a landing bore 950 at least partially within the body 942. The landing bore 950 can be configured to form or shape plasticized material as it flows from the channels 946 and into the bore 948 and the landing bore 950, such that the landing bore 950 can define a cross-sectional profile of the extruded polymer composite. The landing bore 950 can have a relatively long length to help stabilize extrudate formed by the bore 948 and the landing bore 950. For example, a diameter of the bore 948 or the landing bore 950 can be between 0.5 mm and 50 mm. In some examples, the diameter of the bore 948 can be between 1 mm and 5 mm. A length L of the landing bore 950 can be between having a length between 30 mm and 100 mm. In some examples, the length L can be between 40 mm and 75 mm. These values can change depending on the desired diameter of the extruded polymer composite. In operation, the landing bore 950 can help to control the generated geometry of the extrudate as it is processed and begins to form from the plasticized extrudate. Though the landing bore 950 can be relatively long for a ShAPE process, the relatively long landing bore 950 can more simply define the geometry than the processes used in typical thermal extrusion where extruded polymers generate relatively high pressures that resulting in high die swell that can require one or more downstream processes to control extrudate shape or geometry. SAP or ShAPE polymer extrusion can mitigate or reduce die swell and eliminate or reduce polymer melting, eliminating the need for further downstream processing.

After passing through the landing bore 950, the extruded polymer composite can pass into a release section 952. A cross-sectional width or diameter of relief section can be relatively larger that the diameter of the landing bore 950. A cross-sectional profile of the release section 952 can be quadrilateral or circular. The die tool 902 can terminate at an end of the release section 952, which can be in the shape or form of an elongate opening or a circular opening. The overall shape of the extruded polymer composite can be a function of the shape of the landing bore 950 and the release section 952.

The die assembly 902 can also include a sensor 907 connected to any portion of the die assembly 902 (or the die assembly 102). The sensor 907 can be similar to the sensor 107 discussed above and can be configured to generate a signal based on a temperature of or within the die assembly 102. Additional sensors such as those for monitoring parameters such as, pressure, rotational speed or a combination thereof can also be included in the die assembly 102 and can be connected to or located at least partially within the die assembly 102. A controller can be configured to receive a signal from the 907 and can be configured to operate a rotational speed of the spindle 106 or an axial force of the ram 109 based on the signal.

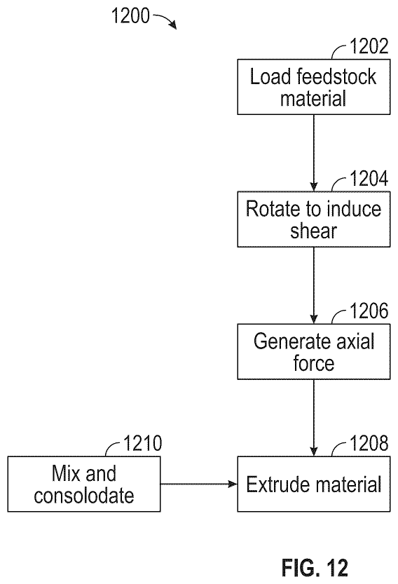

FIG. 12 illustrates a schematic view of the method 1200, in accordance with at least one example of this disclosure. The method 1200 can be a method of SAP extrusion of a polymer composite. More specific examples of the method 1200 are discussed below. The steps or operations of the method 1200 are illustrated in a particular order for convenience and clarity; many of the discussed operations can be performed in a different sequence or in parallel without materially impacting other operations. The method 1200 as discussed includes operations performed by multiple different actors, devices, or systems. It is understood that subsets of the operations discussed in the method 1200 can be attributable to a single actor, device, or system could be considered a separate standalone process or method.

The method 1200 can be a method of extruding a polymer composite. The 1200 can begin at step 1202 where feedstock material comprising a first polymer and a second polymer can be loaded. Optionally, one or more of the polymers can be compressed, compacted, or otherwise formed into a billet shape prior to loading of the feedstock material. For example, the billet material 110 (which can include feedstock material) can be loaded into the container 112. A feed rate of the mixture into the system 100 can be carefully controlled to mitigate against clogging. For example, a feed rate of the mixture can be in a range of from about 4 mm/min to about 50 mm/min, about 5 mm/min to about 15 mm/min, less than, equal to, or greater than about 4 mm/min, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 mm/min.

At step 1204, a rotation-induced shear force can be established at an interface between a face of a die tool and a face of the feedstock material by rotating the feedstock material at a different rate than the die tool. For example, a rotation-induced shear force can be established at an interface between the die face 118 and a face of the feedstock material 110 by rotating the feedstock material at a different rate than the die tool 102.

At step 1206, an axial extrusion force can be established at the interface between the face of the die tool and the face of the feedstock material by translating the die tool relative to the container contemporaneously with the rotation of the die tool relative to the feedstock material. For example, an axial extrusion force can be established at the interface between the face 118 of the die tool and the face of the feedstock material 110 by translating the die tool relative to the container 112. At step 1208, the feedstock material can be extruded through an opening of the die tool using plastic deformation of a solid phase of the feedstock material in response to the rotation and the axial extrusion force at the interface. For example, the feedstock material 110 can be extruded through an opening (e.g., bore 948) of the die tool using plastic deformation in response to the rotational shear and the axial extrusion force at the interface.

In some examples, at step 1210, the first polymer and the second polymer can be mixed and consolidated in a plurality of pathways in the face of the die tool, where the plurality of pathways can be connected to the opening of the die tool. For example, the first polymer 134A and the second polymer 134B can be mixed and consolidated in a plurality of pathways in the face die face 944 of the die tool, where the plurality of pathways 946 can be connected to the opening of the die tool 902. In some examples, during extruding of the feedstock material, the feedstock material is not melted. In some examples, the feedstock material is not melted prior to or during the extruding.

As discussed above, one or more of the first polymer or the second polymer can include scrap or waste polymer such that the polymer is not virgin (newly manufactured) material or has already been used. For example, the first polymer can include scrap or waste associated with a first resin identification code and the second polymer can include scrap or waste associated with a second resin identification code that is different than the first resin identification code. For example, the first polymer can include polypropylene and the second polymer can include low density polyethylene or high density polyethylene. In some examples, the polymer composite can include a mixture of the first polymer and the second polymer. In some examples, the feedstock material can include shredded material, pelletized material, flake material, or the like.

The method 1200 can also optionally include one or more of rotating a container supporting the feedstock material relative to the die tool to establish the rotational shear, maintaining a rotational position of the die tool during extruding, rotating the feedstock material with the container relative to the die tool to establish the rotational shear, and generating extrudate from the feedstock material made of a homogenized mixture of the first polymer and the second polymer.

In some examples, the extruded polymer composite can further include an additive such as a stabilizer, a colorant, a flame retardant, or a mixture thereof. Some illustrative examples of flame retardants include, for example, organophosphorous compounds such as organic phosphates (including trialkyl phosphates such as triethyl phosphate, tris(2-chloropropyl)phosphate, and triaryl phosphates such as triphenyl phosphate and diphenyl cresyl phosphate, resorcinol bis-diphenylphosphate, resorcinol diphosphate, and aryl phosphate), phosphites (including trialkyl phosphites, triaryl phosphites, and mixed alkyl-aryl phosphites), phosphonates (including diethyl ethyl phosphonate, dimethyl methyl phosphonate), polyphosphates (including melamine polyphosphate, ammonium polyphosphates), polyphosphites, polyphosphonates, phosphinates (including aluminum tris(diethyl phosphinate); halogenated fire retardants such as chlorendic acid derivatives and chlorinated paraffins; organobromines, such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD); metal hydroxides such as magnesium hydroxide, aluminum hydroxide, cobalt hydroxide, and hydrates of the foregoing metal hydroxide; and combinations thereof. The flame retardant can be a reactive type flame-retardant (including polyols which contain phosphorus groups, 10-(2,5-dihydroxyphenyl)-10H-9-oxa-10-phospha-phenanthrene-10-oxide, phosphorus-containing lactone-modified polyesters, ethylene glycol bis(diphenyl phosphate), neopentylglycol bis(diphenyl phosphate), amine- and hydroxyl-functionalized siloxane oligomers). These flame retardants can be used alone or in conjunction with other flame retardants.

The method(s) discussed above using SAP or ShAPE processing to recycle multiple polymers or process multiple recycled (or non-virgin polymers) can be helpful in processing polymers that are difficult to separate, such as PE and PP (or others such as linear low density PE, medium density PE, or the like), where similar material properties, such as density, can make separation difficult. However, using SAP or ShAPE, the materials can be loaded as feedstock or billet material without separation to produce a composite or copolymer (e.g., PP and PE) with good retention of mechanical properties such as flexural strength, flexural modulus, toughness, ultimate tensile strength, compressive strength, Young's modulus, hardness, stiffness, and the like.

Further, SAP and ShAPE processes that are used to generate a polymer can save significant energy relative to a polymer processed using standard recycling techniques, which can include chemical separation, thermal extrusion, one or more sizing steps (e.g., vacuum sizing), cooling of the extrudate, and reheating, or the like, prior to cutting or pelletizing the material. SAP and ShAPE processing can help to reduce energy input, thereby reducing cost, during processing by reducing or eliminating one or more steps of chemical separation, thermal extrusion, cooling, reheating, or the like.

Also, typical recycling processes use one or more heating steps prior to or during extrusion (e.g., thermal extrusion) where such heating processes cause thermal degradation of the polymer(s) being processed. These issues can be exacerbated when processing mixed plastics because the highest melt temperature often must be reached which can cause further thermal degradation of the polymer with a lower melt temperature. And, when the highest melt temperature is not achieved, some portions (e.g., flakes or pellets) may not melt, resulting in inclusions within the extrudate. Use of SAP and ShAPE processes to generate a composite polymer or copolymer can generate extrudate with improved (or better retained) mechanical properties, such as those listed above, by using solid phase processing where only rotation induced shear and linear axial forces are used for extrusion and the material is not melted (or is minimally melted) during the process.

### Notes and Examples

The following, non-limiting examples, detail certain aspects of the present subject matter to solve the challenges and provide the benefits discussed herein, among others.

Example 1 is a method of extruding a polymer composite, the method comprising: loading a feedstock material comprising a first polymer and a second polymer; establishing shear at an interface between a face of a die tool and a face of the feedstock material by establishing rotation of the die tool relative to the feedstock material; establishing an axial extrusion force at the interface between the face of the die tool and the face of the feedstock material by translating the die tool relative to the feedstock material, contemporaneously with the rotation of the die tool relative to the feedstock material; and extruding the feedstock material through an opening of the die tool using plastic deformation of a solid phase of the feedstock material in response to the rotation and the axial extrusion force at the interface.

In Example 2, the subject matter of Example 1 optionally includes wherein extruding the feedstock material does not melt the feedstock material.

In Example 3, the subject matter of any one or more of Examples 1-2 optionally include wherein the feedstock material is not melted prior to or during the extruding.

In Example 4, the subject matter of any one or more of Examples 1-3 optionally include wherein one or more of the first polymer or the second polymer comprises scrap or waste; and wherein the polymer composite comprises a mixture of the first polymer and the second polymer.

In Example 5, the subject matter of Example 4 optionally includes wherein the first polymer comprises scrap or waste associated with a first resin identification code and the second polymer comprises scrap or waste associated with a different second resin identification code.

In Example 6, the subject matter of any one or more of Examples 4-5 optionally include wherein the first polymer comprises polypropylene and the second polymer comprises low density polyethylene or high density polyethylene.

In Example 7, the subject matter of any one or more of Examples 1-6 optionally include wherein the feedstock material comprises shredded material, pelletized material, or flake material.

In Example 8, the subject matter of any one or more of Examples 1-7 optionally include mixing and consolidating the first polymer and the second polymer in a plurality of pathways in the face of the die tool, the plurality of pathways connected to the opening of the die tool.

In Example 9, the subject matter of any one or more of Examples 1-8 optionally include rotating a container supporting the feedstock material relative to the die tool to establish the rotational shear; maintaining a rotational position of the die tool during extruding; rotating the feedstock material with the container relative to the die tool to establish the rotational shear; and generating extrudate from the feedstock material made of a homogenized mixture of the first polymer and the second polymer.

In Example 10, the subject matter of any one or more of Examples 1-9 optionally include wherein the opening connected to the face of the die tool is a circular bore having a diameter between 1 mm and 5 mm and having an axial length between 30 mm and 100 mm.

Example 11 is a method of extruding a polymer composite, the method comprising: loading into a container feedstock material comprising a first polymer type and a second polymer type different from the first polymer type; establishing rotational shear at an interface between a face of a die tool and a face of the feedstock material by rotating the feedstock material at a different rate than the die tool; establishing an axial extrusion force at the interface between the face of the die tool and the face of the feedstock material by translating the die tool relative to the container; and producing extrudate by extruding the feedstock material through an opening of the die tool using plastic deformation in response to the rotational shear and the axial extrusion force at the interface.

In Example 12, the subject matter of Example 11 optionally includes wherein the first polymer type is a first type of recycled polymer and the second polymer type is a second type of recycled polymer.

In Example 13, the subject matter of Example 12 optionally includes generating extrudate from the feedstock material made of a homogenized mixture of the first type of recycled polymer and the second type of recycled polymer.

In Example 14, the subject matter of any one or more of Examples 12-13 optionally include wherein the first type of recycled polymer is recycled polypropylene and the second type of recycled polymer is recycled low density polyethylene or recycled high density polyethylene.

In Example 15, the subject matter of any one or more of Examples 11-14 optionally include mixing and consolidating the first polymer type and the second polymer type in a plurality of pathways in the face of the die tool, the plurality of pathways connected to the opening of the die tool.

In Example 16, the subject matter of any one or more of Examples 11-15 optionally include wherein the feedstock material is pelletized or flake.

In Example 17, the subject matter of any one or more of Examples 11-16 optionally include rotating the container relative to the die tool to establish the rotational shear.

In Example 18, the subject matter of Example 17 optionally includes maintaining a rotational position of the die tool during extruding.

In Example 19, the subject matter of Example 18 optionally includes rotating the feedstock material with the container relative to the die tool to establish the rotational shear.

In Example 20, the subject matter of any one or more of Examples 11-19 optionally includes wherein extruding the feedstock material does not melt the feedstock material.

In Example 21, the subject matter of any one or more of Examples 11-20 optionally include wherein the feedstock material is not melted prior to or during the extruding.

In Example 22, the apparatuses or method of any one or any combination of Examples 1-21 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of extruding a polymer composite, the method comprising:
loading a feedstock material comprising a first polymer and a second polymer;
establishing shear at an interface between a face of a die tool and a face of the feedstock material by establishing rotation of the die tool relative to the feedstock material;
establishing an axial extrusion force at the interface between the face of the die tool and the face of the feedstock material by translating the die tool relative to the feedstock material, contemporaneously with the rotation of the die tool relative to the feedstock material; and
extruding the feedstock material through an opening of the die tool using plastic deformation of a solid phase of the feedstock material in response to the rotation and the axial extrusion force at the interface.

2. The method of claim 1, wherein extruding the feedstock material does not melt the feedstock material.

3. The method of claim 1, wherein the feedstock material is not melted prior to or during the extruding.

4. The method of claim 1, wherein one or more of the first polymer or the second polymer comprises scrap or waste; and
wherein the polymer composite comprises a mixture of the first polymer and the second polymer.

5. The method of claim 4, wherein the first polymer comprises scrap or waste associated with a first resin identification code and the second polymer comprises scrap or waste associated with a different second resin identification code.

6. The method of claim 4, wherein the first polymer comprises polypropylene and the second polymer comprises low density polyethylene or high density polyethylene.

7. The method of claim 1, wherein the feedstock material comprises shredded material, pelletized material, or flake material.

8. The method of claim 1, comprising:
mixing and consolidating the first polymer and the second polymer in a plurality of pathways in the face of the die tool, the plurality of pathways connected to the opening of the die tool.

9. The method of claim 1, comprising:
rotating a container supporting the feedstock material relative to the die tool to establish the rotational shear;
maintaining a rotational position of the die tool during extruding;
rotating the feedstock material with the container relative to the die tool to establish the rotational shear; and
generating extrudate from the feedstock material made of a homogenized mixture of the first polymer and the second polymer.

10. The method of claim 1, wherein the opening connected to the face of the die tool is a circular bore having a diameter between 1 mm and 5 mm and having an axial length between 30 mm and 100 mm.

11. A method of extruding a polymer composite, the method comprising:
loading into a container feedstock material comprising a first polymer type and a second polymer type different from the first polymer type;
establishing a rotation-induced shear force shear at an interface between a face of a die tool and a face of the feedstock material by rotating the feedstock material at a different rate than the die tool;
establishing an axial extrusion force at the interface between the face of the die tool and the face of the feedstock material by translating the die tool relative to the container; and
producing extrudate by extruding the feedstock material through an opening of the die tool using plastic deformation in response to the rotational shear and the axial extrusion force at the interface.

12. The method of claim 11, wherein the first polymer type is a first type of recycled polymer and the second polymer type is a second type of recycled polymer.

13. The method of claim 12, comprising:
generating extrudate from the feedstock material made of a homogenized mixture of the first type of recycled polymer and the second type of recycled polymer.

14. The method of claim 12, wherein the first type of recycled polymer is recycled polypropylene and the second type of recycled polymer is recycled low density polyethylene or recycled high density polyethylene.

15. The method of claim 11, comprising:
mixing and consolidating the first polymer type and the second polymer type in a plurality of pathways in the face of the die tool, the plurality of pathways connected to the opening of the die tool.

16. The method of claim 11, wherein the feedstock material is pelletized or flake.

17. The method of claim 11, comprising:
rotating the container relative to the die tool to establish the rotational shear.

18. The method of claim 17, comprising:
maintaining a rotational position of the die tool during extruding.

19. The method of claim 18, comprising:
rotating the feedstock material with the container relative to the die tool to establish the rotational shear.

20. The method of claim 11, wherein the feedstock material is not melted prior to or during the extruding.
